(19) United States
(12) Patent Application Publication
(10) Pub. No.: US 2026/0080805 A1
(43) Pub. Date: Mar. 19, 2026

(54) TRAINING APPARATUS FOR SIMULATING A PELVIC EXAMINATION

(71) Applicant: GRANVILLE BIOMEDICAL INC., St. John's (CA)

(72) Inventors: Christine GOUDIE, St. John's (CA); Rebecca Min WYTSMA, St. John's (CA); Christopher Adam PRESS, St. John's (CA)

(21) Appl. No.: 19/330,108

(22) Filed: Sep. 16, 2025

Related U.S. Application Data
(60) Provisional application No. 63/695,707, filed on Sep. 17, 2024.

(51) Int. Cl. G09B 23/34; G09B 23/32

(52) U.S. Cl. CPC G09B 23/34; G09B 23/32

(57) ABSTRACT

There is provided a training apparatus for simulating a pelvic examination, the training apparatus comprising an anatomy model, a plurality of cervix models, a movable holder, and a base. There is also provided kits and uses thereof. There is also provided a method for simulating a pelvic examination.

### CROSS-REFERENCE TO RELATED APPLICATION

This application claims priority to U.S. Patent Application Ser. No. 63/695,707 filed on Sep. 17, 2024, which is hereby incorporated by reference in its entirety.

### TECHNICAL FIELD

The present disclosure relates generally to training apparatuses for simulating pelvic examinations. More specifically, the present disclosure relates to a training apparatus having a movable holder for aligning each cervix model of a plurality of cervix models with an anatomy model.

### BACKGROUND

Anatomy and pathological models provide interactive and life-like training tools for healthcare practitioners and students to use to practice and simulate pelvic examinations.

Current anatomy models, particularly those for modelling cervical pathologies, are generally provided in one of two forms. The first form comprises kits having cervix models that can be inserted into an accompanying vulva or vaginal canal model. In this form, each cervix model is individually placed into the vulva or vaginal canal model for viewing or for simulating a pelvic examination. The second form comprises boards with a variety of cervical pathologies that are intended to be viewed as a whole without an accompanying vulva or vaginal canal model. Examples of current anatomy models are provided as follows.

U.S. Pat. No. 5,472,345 (Eggert) discloses a gynecological simulator for training medical personnel in gynecological procedures, including a body simulating the torso of a human female having an internal cavity therein. A flexible vagina having a proximal end fixed to the body and a distal end extending inwardly into the cavity removably receives a securely retained cervix and a rotatable uterus by means of a locking ring and locking cap, respectively, both threadably engaged to a threaded pedestal secured to the cervix. Fallopian tubes, ovaries and round ligaments are provided removably attached to the uterus, and incisions are disposed in the skin encasing the simulator for enabling laparoscopy and minilaparotomy to be performed on the fallopian tubes.

U.S. Pat. No. 6,428,323 (Pugh) discloses a teaching system for training students to perform exams manually inside a body cavity. The system contains an anatomical simulator made from a manikin. The manikin has simulator cavities and a tactile sensor that is located within the manikin so as to generate a signal in response to manual contact with an inside surface of the simulator cavity. The system also contains a feedback presentation unit, which is in communication with a sensor. To perform the exam, the student places a hand into the opening, which gives access to a cavity and executes a series of steps. In one embodiment the system is used to teach pelvic exams, wherein removable organs such as a uterus and an attached cervix are used in the anatomical simulator.

There are several issues with the current anatomy model technology. Cervical models or pathologies are intended to be viewed one-by-one, and do not allow for sequential viewing without removal of a selected cervical model from the accompanying vulva or vaginal canal model. Moreover, the cervical model and/or the accompanying vulva or vaginal canal model may not be life-like and thus, may not allow healthcare practitioners and students to realistically simulate a pelvic examination as would be experienced in real life clinical settings.

A need therefore exists for improved training apparatuses for simulating pelvic examinations that provide for practice identifying and sampling cervical pathologies.

### SUMMARY

The present disclosure provides apparatuses, uses, kits, and methods for simulating a pelvic examination. The present disclosure recognizes that there are challenges in the current existing technologies in respect of anatomy models, such as user friendliness for viewing multiple cervical pathologies sequentially and the life-likeness of said anatomy models.

An advantage of the present disclosure is the provision of improved apparatuses, uses, kits, and methods for simulating a pelvic examination over existing technologies.

In some embodiments, the present disclosure relates to a training apparatus for simulating a pelvic examination, comprising: an anatomy model comprising a vaginal canal, the vaginal canal having a tube-like structure and comprising a viewing end and an open end opposite the viewing end; a plurality of cervix models, each cervix model of the plurality of cervix models for displaying a cervical pathology; a movable holder comprising two or more cervix model receiving formations, each of the cervix model receiving formations for removably attaching one of the cervix models; and a base for supporting the movable holder, the base comprising one or more motion-limiting formations for defining a path of motion of the movable holder upon the base, and the base configured to align each cervix model of the plurality of cervix models with the open end of the vaginal canal upon movement of the movable holder along the path of motion.

In some embodiments, the present disclosure relates to a kit for simulating a pelvic examination, comprising: any one of the training apparatuses as described herein; and one or more procedural tools.

In some embodiments, the present disclosure relates to a use of any one of the training apparatuses or any one of the kits as described herein for simulating a pelvic examination.

In some embodiments, the present disclosure relates to a use of any one of the training apparatuses or any one of the kits as described herein for educating a user.

In some embodiments, the present disclosure relates to a method for simulating a pelvic examination, comprising steps of: providing a movable holder onto a base; arranging a plurality of cervix models within two or more cervix model receiving formations of the movable holder, each cervix model of the plurality of cervix models for displaying a cervical pathology; identifying a selected cervix model of the plurality of cervix models; actuating the movable holder along a path of motion defined by the base to align the selected cervix model of the plurality of cervix models with an open end of a vaginal canal of an anatomy model, the vaginal canal having a tube-like structure; and viewing or conducting a pelvic examination of the selected cervix model of the plurality of cervix models through the anatomy model from a viewing end of the vaginal canal.

Other aspects and embodiments of the disclosure are evident in view of the detailed description provided herein.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIGS. 1A and 1B show an illustrative training apparatus for simulating a pelvic examination according to an embodiment of the present disclosure, wherein FIG. 1A is a side perspective view and FIG. 1B is front perspective view.

FIGS. 2A and 2B show an illustrative anatomy model that can be used in the training apparatus of FIG. 1A according to an embodiment of the present disclosure, wherein FIG. 2A is a side view and FIG. 2B is a front view.

FIG. 3 is a perspective view of an illustrative stand that can be used in the training apparatus of FIG. 1A according to an embodiment of the present disclosure.

FIG. 4 is a perspective view of an illustrative base that can be used in the training apparatus of FIG. 1A according to an embodiment of the present disclosure, whereby the base has a negative alignment pattern for mounting on the stand.

FIG. 5 shows an alternative embodiment of an illustrative base that can be used in the training apparatus of FIG. 1A according to an embodiment of the present disclosure. A negative alignment pattern is not shown, but the base of this embodiment can be modified to have the negative alignment pattern.

FIG. 6 shows an alternative embodiment of an illustrative base that can be used in the training apparatus of FIG. 1A according to an embodiment of the present disclosure. A negative alignment pattern is not shown, but the base of this embodiment can be modified to have the negative alignment pattern.

FIG. 7 shows an alternative embodiment of an illustrative base that can be used in the training apparatus of FIG. 1A according to an embodiment of the present disclosure. A negative alignment pattern is not shown, but the base of this embodiment can be modified to have the negative alignment pattern.

FIG. 8 is a perspective view of an illustrative base and stand that can be used in the training apparatus of FIG. 1 according to an embodiment of the present disclosure.

FIGS. 9A and 9B show an illustrative movable holder that can be used in the training apparatus of FIG. 1, wherein FIG. 9A is a perspective side view and FIG. 9B is a cross-section view taken along line 9B-9B shown in FIG. 9A.

FIG. 10 shows an illustrative movable holder that can be used in the training apparatus of FIG. 1A.

FIG. 11 shows another illustrative movable holder that can be used in the training apparatus of FIG. 1A.

FIG. 12 shows another illustrative movable holder that can be used in the training apparatus of FIG. 1A.

FIG. 13 shows a further illustrative movable holder that can be used in the training apparatus of FIG. 1A, wherein the one or more grips are protruding spheres.

FIG. 14 shows a further illustrative movable holder that can be used in the training apparatus of FIG. 1A, wherein the one or more grips are recessed holes.

FIGS. 15A and 15B show a further illustrative movable holder and base that can be used in the training apparatus of FIG. 1A, wherein FIG. 15A shows a top perspective view of the base and FIG. 15B shows a bottom perspective view of the movable holder.

FIG. 16 is a perspective view of an illustrative plurality of cervix models that can be used in the training apparatus of FIG. 1A according to an embodiment of the present disclosure.

FIG. 17 shows a further illustrative training apparatus for simulating a pelvic examination according to an embodiment of the present disclosure, wherein the plurality of cervix models protrude outwards from the moveable holder (rather then recessed such as shown in FIG. 1A).

FIG. 18 is a perspective view of an illustrative stand that can be used in the training apparatus of the present disclosure, such as the training apparatus of FIG. 17.

FIG. 19 is a perspective view of an illustrative cervix model that can be used in the training apparatus of FIG. 17 according to an embodiment of the present disclosure.

FIG. 20 is a perspective view of an illustrative training apparatus for simulating a pelvic examination according to an embodiment of the present disclosure.

FIG. 21 is a flowchart showing the steps of simulating a pelvic examination, according to some embodiments of the present disclosure.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

The present disclosure provides a training apparatus for simulating a pelvic examination, kits for use thereof in a pelvic examination simulation, a use of any one of the training apparatus described herein, and a method for simulating a pelvic examination.

The present disclosure recognizes that there are problems in currently existing pelvic examination training apparatuses in respect of utility, functionality, and accuracy. The training apparatus of the present disclosure is advantageous in several aspects, including having an all-encompassing life-like anatomy model for procedural demonstrations, cervix models with anatomically accurate features and a realistic look and feel, and a user-friendly movable functionality.

Another advantage of the present disclosure is that the training apparatus of the present disclosure has the features and functionality to provide a wide-range of utility across a number of difficult training, practice, and educational applications. Unlike many models which are rigid and lack sufficient features to function as accurate educational tools, the training apparatus of the present disclosure is realistic and life-like, allowing for insertion of various procedural tools and simulation of various pelvic examination procedures.

Particularly advantageous to the improved utility of the training apparatus is its movable functionality. The training apparatus of the present disclosure has a movable holder for displaying the cervix models. The movable holder neatly secures the cervix models and is movable to display the cervix models from different positions. The movable holder also allows any of the cervix models to smoothly move into alignment with an open end of a vaginal canal, where pelvic examinations may be conducted on the aligned cervix model. The presence of a movable feature renders the training apparatus engaging and user-friendly. Such movable feature may be, without limitation, a rotational movement, a slidable movement, and/or a translational movement.

Thus, the training apparatus of the present disclosure offers a life-like apparatus for healthcare professionals to demonstrate various pelvic examination techniques, including visual cervical examinations, Papanicolaou (Pap) smears, colposcopies, cervical biopsies, endocervical curettage, and late pregnancy cervical examinations. The training apparatus of the present disclosure may advantageously foster confidence for healthcare professionals in their understanding of pelvic health and in their pelvic examination skills.

In some embodiments, the present disclosure relates to a training apparatus for simulating a pelvic examination, comprising: an anatomy model comprising a vaginal canal, the vaginal canal having a tube-like structure and comprising a viewing end and an open end opposite the viewing end; a plurality of cervix models, each cervix model of the plurality of cervix models for displaying a cervical pathology; a movable holder comprising two or more cervix model receiving formations, each of the cervix model receiving formations for removably attaching one of the cervix models; and a base for supporting the movable holder, the base comprising one or more motion-limiting formations for defining a path of motion of the movable holder upon the base, and the base configured to align each cervix model of the plurality of cervix models with the open end of the vaginal canal upon movement of the movable holder along the path of motion.

As used herein, the term “anatomy model” refers to a three-dimensional representation of human anatomy. In some embodiments, the anatomy model comprises female reproductive organs and areas surrounding said organs. As used herein, the terms “vaginal canal”, “cervix”, “vulva”, and “uterus” are intended to have the normal meanings ascribed to these terms. A skilled person in the art will understand that the anatomy model of the present disclosure may resemble any anatomically and physiologically correct vaginal canal and/or vulva of any person who has said anatomical parts, including and without limitation, any race, age, weight, genetic background, or health status. Without being bound by any particular theory, certain forms of anatomy models may be chosen depending on the training or simulation context or the user of the training apparatus.

As used herein, the term “cervix model” refers to a three-dimensional representation of a cervix. The cervix model may display features including, but not limited to, procedural or parity variations and cervical pathologies. In some embodiments, the cervical pathology comprises a normal cervix, a trichomoniasis cervix, a Nabothian cyst cervix, an ectropion cervix, a polyp cervix, a condyloma cervix, a cancer cervix, a dysplasia cervix, a cervicitis cervix, a bacterial vaginosis cervix, a candidiasis cervix, a genital herpes cervix, or a syphilis cervix.

In some embodiments, the anatomy model and the plurality of cervix models comprise a natural rubber, synthetic rubber, urethane, polyurethane, silicone, the like, or any combination thereof. In some embodiments, the anatomy model and the plurality of cervix models comprise silicone.

As used herein, the term “cervix model receiving formations” refers to any structure, appendage, recess, and the like suitable for receiving the plurality of cervix models. In some embodiments, the two or more cervix model receiving formations comprise a cavity, a hook, a protrusion, a textured surface, a Velcro® hook, a Velcro® loop, or any combination thereof. In some embodiments, each of the two or more cervix model receiving formations comprises one or both of a cavity and a protrusion. In some embodiments, each of the two or more cervix model receiving formations comprises a cavity. In some embodiments, each of the two or more cervix model receiving formations comprises a protrusion. In some embodiments, each of the two or more cervix model receiving formations are positioned equidistant from one another.

In some embodiments, the anatomy model further comprises a vulva extending outward from the vaginal canal at the viewing end.

In some embodiments, the anatomy model further comprises a stand for supporting the anatomy model that is configured to align, in cooperation with the base, the open end of the vaginal canal with each cervix model of the plurality of cervix models upon movement of the movable holder.

A skilled person in the art will understand that the stand and the base may each or together have any shape, structure, or formation suitable for supporting the anatomy model and supporting the movable holder, respectively. In some embodiments, when the training apparatus is in operation, the base is stationary and provides a surface for the movable holder to slide and/or pivot upon.

In some embodiments, the stand and the base are a monolithic unit.

In some embodiments, the stand and the base are separate units. In some embodiments, the stand and the base are capable of being releasably interconnected. In some embodiments, the releasable interconnection comprises a positive alignment pattern on one of the base or the stand and a negative alignment pattern on the other one of the base or the stand. In some embodiments, the positive alignment pattern comprises a protrusion, a pin, a plug, a male connector, the like, or any combination thereof. In some embodiments, the negative alignment pattern comprises a recess, a cavity, a female connector, the like, or any combination thereof.

In some embodiments, the stand further comprises one or more surface grips on a bottom surface of the stand. In some embodiments, the surface grips comprise rubber feet, bumper pads, a textured surface, a textile, a screw, a clamp, the like, or any combination thereof.

In some embodiments, the stand positions a longitudinal length of the vaginal canal of the anatomy model at a first angle within a range of about 20° and 70° relative to a horizontal axis. In some embodiments, the stand positions a longitudinal length of the vaginal canal of the anatomy model at a first angle within a range of about 30° and 60° relative to a horizontal axis. In some embodiments, the stand positions a longitudinal length of the vaginal canal of the anatomy model at a first angle within a range of about 40° and 50° relative to a horizontal axis.

In some embodiments, the base positions the movable holder in an orientation such that a feature surface of each cervix model of the plurality of cervix models is at an angle of about 60° relative to the longitudinal length of the vaginal canal, about 70° relative to the longitudinal length of the vaginal canal, about 80° relative to the longitudinal length of the vaginal canal, or about 90° relative to the longitudinal length of the vaginal canal. In some embodiments, the base positions the movable holder in an orientation such that a feature surface of each cervix model of the plurality of cervix models is at an angle of about 90° relative to the longitudinal length of the vaginal canal.

In some embodiments, the movable holder positions the plurality of cervix models at a second angle within a range of about 20° and 70° relative to a horizontal axis. In some embodiments, the movable holder positions the plurality of cervix models at a second angle within a range of about 30° and 60° relative to a horizontal axis. In some embodiments, the movable holder positions the plurality of cervix models at a second angle within a range of about 40° and 50° relative to a horizontal axis.

Without being bound by any particular theory, the plurality of cervix models may be positioned at an angle that is complementary to the angle of the anatomy model such that the user can see the entirety of the feature surface of a selected cervix model to view and identify a cervical pathology.

As used herein, the term “motion-limiting formation” refers to any structure, appendage, recess, and the like suitable for defining the path of motion such that the movable holder can only be actuated along said path of motion. In some embodiments, the motion-limiting formation comprises a cylindrical pin, an axle, a track, a wheel, a pulley, a channel, a wall, a ridge, the like, or any combination thereof. In some embodiments, the path of motion is linear, curvilinear, random, oscillatory, translational, rotational, or any combination thereof.

In some embodiments, the path of motion is rotational. In some embodiments, the one or more motion-limiting formations comprises a cylindrical pin. In some embodiments, the cylindrical pin comprises a first end connecting to the base and a second end opposite the first end, wherein a first diameter of the first end is larger than a second diameter of the second end. In some embodiments, the movable holder has a conical shape.

In some embodiments, the path of motion is translational. In some embodiments, the one or more motion-limiting features is a wall or a ridge.

In some embodiments, the base and the movable holder comprise a plurality of alignment formations that, when in operation, aligns each cervix model of the plurality of cervix models with the open end of the vaginal canal upon movement of the movable holder along the path of motion. In some embodiments, the plurality of alignment formations comprise a textured surface, a textile, a notch, a protrusion, a recess, a magnet, the like, or any combination thereof. In some embodiments, the plurality of alignment formations comprises a plurality of protrusions on the base and a plurality of recesses on the moving holder. In some embodiments, the plurality of alignment formations comprises at least one base magnet on the base and a plurality of holder magnets on the moving holder. Without being bound by any particular theory, the plurality of alignment formations allow for a user to actuate the movable holder such that the movable holder will stop at a position that aligns a selected cervix model with the open end of the vaginal canal unless further force is applied to actuate the movable holder to align a next cervix model.

In some embodiments, the movable holder further comprises one or more actuators. In some embodiments, the one or more actuators comprises a motor, a grip, a knob, a button, a disc, a dial, the like, or any combination thereof. In some embodiments, the one or more actuators comprises one or more grips.

In some embodiments, each cervix model in the plurality of cervix models comprises a vaginal mount and a cervix. In some embodiments, the vaginal mount comprises a container defining a mount cavity, and the cervix is received within the mount cavity. In some embodiments, the open end of the vaginal canal comprises an inner canal diameter and an outer canal diameter. In some embodiments, the vaginal mount comprises an inner mount diameter and an outer mount diameter. In some embodiments, the inner mount diameter and the inner canal diameter are equal and/or the outer mount diameter and the outer canal diameter are equal. In some embodiments, each cervix model in the plurality of cervix models is configured to be releasably received into the open end of the vaginal canal through an interference fit. In some embodiments, the outward facing surface of the cervix and the vaginal mount comprise a feature surface of the cervix model. As used herein, the term “feature surface” refers to the surface of the plurality of cervix models that is visible to the user through the vaginal canal of the anatomy model or that is visible to the user when received within the two or more cervix model receiving formations.

In some embodiments, the plurality of cervix models comprises at least two cervix models, and the two or more cervix model receiving formations comprise at least two cervix model receiving formations. In some embodiments, the plurality of cervix models comprises at least three cervix models, and the two or more cervix model receiving formations comprise at least three cervix model receiving formations. In some embodiments, the plurality of cervix models comprises at least seven cervix models, and the two or more cervix model receiving formations comprise at least seven cervix model receiving formations. In some embodiments, the plurality of cervix models comprises more than seven cervix models, and the two or more cervix model receiving formations comprise more than seven cervix model receiving formations.

As used herein, the term “interference fit” refers to any registering two items by pushing one item into another item wherein the dimensions of both items are such that the items are tightly registered and held together by friction. In some embodiments, the plurality of cervix models is configured to be releasably received in the two or more cervix model receiving formations through interference fits.

In some embodiments, the open end of the vaginal canal and the selected cervix model are separated by a space within a range of about 1 mm and about 4 mm when aligned. In some embodiments, the open end of the vaginal canal and the selected cervix model are separated by a space within a range of about 0.5 mm and about 3 mm when aligned. In some embodiments, the open end of the vaginal canal and the selected cervix model are separated by a space within a range of about 0.25 mm and about 1.5 mm when aligned. In some embodiments, the open end of the vaginal canal and the selected cervix model are separated by a space of about 0.25 mm of space when aligned, about 0.5 mm of space when aligned, about 0.75 mm of space when aligned, about 1 mm of space when aligned, about 2 mm of space when aligned, or about 4 mm of space when aligned. In some embodiments, the open end of the vaginal canal and the selected cervix model are separated by a space of about 1 mm of space when aligned.

In some embodiments, the vaginal canal has a length within a range of about 40 mm and about 100 mm. In some embodiments, the vaginal canal has a length within a range of about 50 mm and about 90 mm. In some embodiments, the vaginal canal has a length of about 70 mm.

In some embodiments, the present disclosure relates to a kit for simulating a pelvic examination, comprising: any one of the training apparatuses as described herein; and one or more procedural tools. In some embodiments, the one or more procedural tools comprises a speculum, a swab, a spatula, a lubricating substance, a light, a colposcope, a curette, an acetic acid solution, forceps, or any combination thereof. In some embodiments, the kit further comprises instructions for use of the training apparatus in a pelvic examination simulation.

In some embodiments, the present disclosure relates to a use of any one of the training apparatuses or any one of the kits as described herein for simulating a pelvic examination.

In some embodiments, the present disclosure relates to a use of any one of the training apparatuses or any one of the kits as described herein for educating a user. In some embodiments, the user comprises a physician, a patient, a nurse, a student, an instructor, or any combination thereof.

In some embodiments, the present disclosure relates to a method for simulating a pelvic examination, comprising steps of: providing a movable holder onto a base; arranging a plurality of cervix models within two or more cervix model receiving formations of the movable holder, each cervix model of the plurality of cervix models for displaying a cervical pathology; identifying a selected cervix model of the plurality of cervix models; actuating the movable holder along a path of motion defined by the base to align the selected cervix model of the plurality of cervix models with an open end of a vaginal canal of an anatomy model, the vaginal canal having a tube-like structure; and viewing or conducting a pelvic examination of the selected cervix model of the plurality of cervix models through the anatomy model from a viewing end of the vaginal canal.

In some embodiments, the steps of arranging the plurality of cervix models, identifying the selected cervix model, actuating the movable holder, and viewing or conducting a pelvic examination of the selected cervix model are repeated.

In some embodiments, the step of viewing or conducting a pelvic examination of the selected cervix model further comprises viewing or conducting the pelvic examination through a vulva. Without being bound by any particular theory, viewing or conducting the pelvic examination through a vulva and a vaginal canal allows a user to more realistically simulate a pelvic examination.

In some embodiments, the method further comprises a step of positioning the anatomy model on a stand to align, in cooperation with the base, the open end of the vaginal canal with the selected cervix model.

In some embodiments, the method further comprises a step of securing the stand to a surface.

In some embodiments, the step of positioning the anatomy model on the stand comprises positioning a longitudinal length of the vaginal canal at a first angle within a range of about 30° and 60° relative to a horizontal axis.

In some embodiments, a step of orienting the base to position the movable holder such that a feature surface of the selected cervix model of the plurality of cervix models is at an angle of about 90° relative to the longitudinal length of the vaginal canal.

In some embodiments, the method further comprises a step of orienting the movable holder to position the plurality of cervix models at a second angle within a range of about 30° and 60° relative to a horizontal axis.

In some embodiments, the method further comprises a step of connecting the base and the stand.

In some embodiments, the step of actuating the movable holder comprises rotating the movable holder on the base along the path of motion. In some embodiments, the step of actuating the movable holder comprises translating the movable holder on the base along the path of motion.

In some embodiments, aligning the selected cervix model with the open end of the vaginal canal in the step of actuating the movable holder comprises registering one of a plurality of alignment formations of the movable holder with a respective one of a plurality of alignment formations of the base.

In some embodiments, the plurality of alignment formations of the base comprise a plurality of protrusions and the plurality of alignment formations of the movable holder comprise a plurality of recesses. In some embodiments, the plurality of alignment formations of the base comprise at least one base magnet and the plurality of alignment formations of the movable holder comprise a plurality of holder magnets.

In some embodiments, aligning the selected cervix model with the open end in the step of actuating the movable holder comprises: aligning an inner mount diameter of the selected cervix model with an inner canal of the open end of the vaginal canal, wherein the inner mount diameter and an inner canal diameter of the inner canal are equal; and/or aligning an outer mount diameter of the selected cervix model with an outer canal of the open end of the vaginal canal, wherein the outer mount diameter and an outer canal diameter of the outer canal are equal.

In some embodiments, the step of actuating the movable holder comprises grasping and pushing one or more grips of the movable holder.

In some embodiments, the method further comprises a step of identifying the cervical pathology of the selected cervix model.

In some embodiments, the step of arranging the plurality of cervix models within the two or more cervix model receiving formations comprises releasably receiving the plurality of cervix models within the two or more cervix model receiving formations through interference fits.

In some embodiments, the method further comprises steps of: removing the selected cervix model from the movable holder; and placing the selected cervix model into the open end of the vaginal canal using an interference fit.

In some embodiments, the method further comprises steps of: positioning a speculum within the vaginal canal through the viewing end of the vaginal canal; inserting a swab into the viewing end of the vaginal canal; and swabbing the selected cervix model with the swab through the vaginal canal.

In some embodiments, the method further comprises a step of inserting the speculum through the vulva.

Reference will now be made to exemplary embodiments of the disclosure, wherein numerals refer to like components, examples of which are illustrated in the accompanying drawings that further show illustrative embodiments, without limitation.

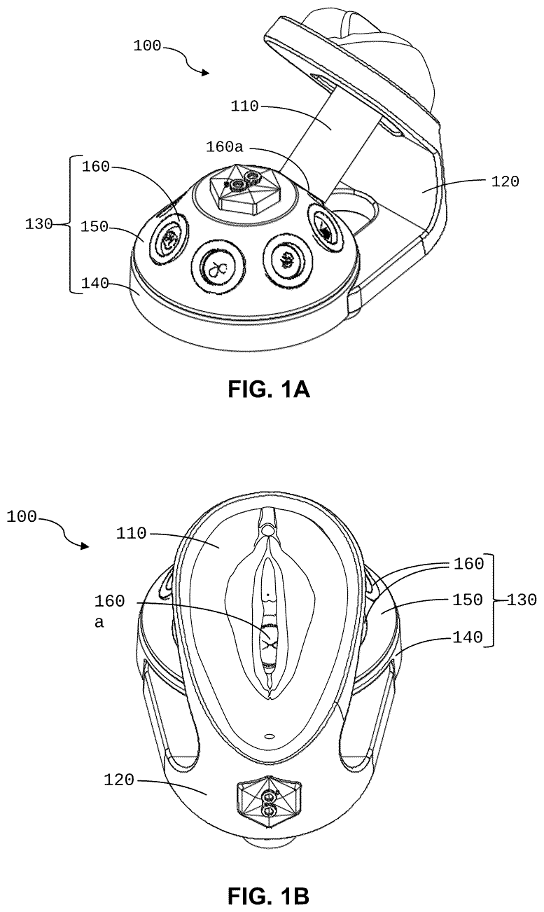

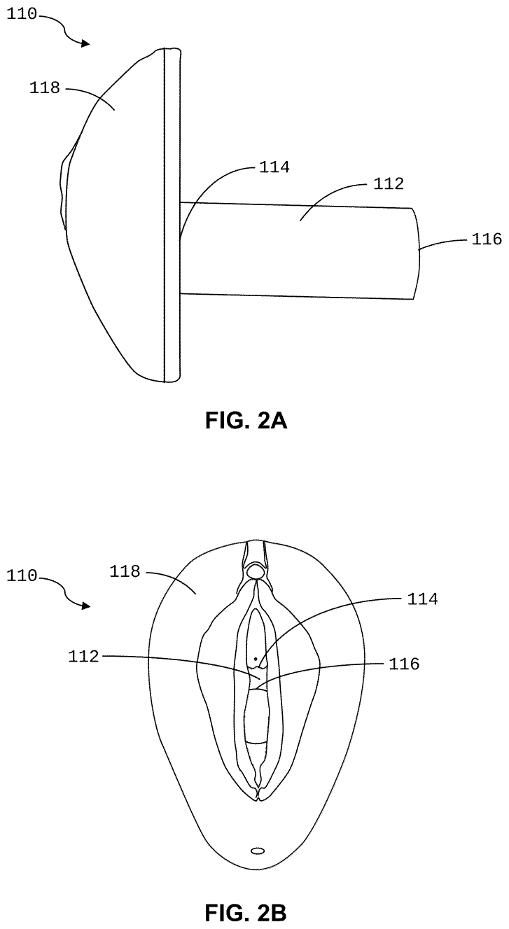

Referring now to FIGS. 1A and 1B, shown therein is an example of a training apparatus 100 for simulating a pelvic examination. The training apparatus 100 comprises an anatomy model 110, an optional stand 120, and a cervix display 130. The cervix display 130 comprises a base 140, a movable holder 150, and a plurality of cervix models 160, including a selected cervix model 160a. FIG. 1A shows a side perspective view of the training apparatus 100. FIG. 1B shows a front perspective view of the training apparatus 100, and in particular the inclined surface of the stand 120 displaying the anatomy model 110 and the view of the selected cervix model 160a through the anatomy model 110. As can be seen from FIGS. 1A and 1B, the training apparatus 100 displays the plurality of cervix models 160 in the movable holder 150. The movable holder 150 is also configured to slide on the base 140 to move a selected cervix model 160a into alignment with the anatomy model 110. The selected cervix model 160a may be viewed and examined through the anatomy model 110. Each element of the training apparatus 100 will now be described in detail according to FIGS. 2 to 16.

Referring now to FIGS. 2A and 2B, an exemplary anatomy model 110 of training apparatus 100 is shown in greater detail. FIG. 2A shows a side view of the anatomy model 110, and FIG. 2B shows a front view of the anatomy model 110. The anatomy model 110 comprises a vaginal canal 112. The vaginal canal 112 is a hollow tube-like structure. The vaginal canal 112 includes a viewing end 114 and an open end 116. The viewing end 114 of the vaginal canal 112 represents the introitus, or the distal end, of the human female vagina. The open end 116 represents the cervical, or proximal end, of the human female vagina.

The vaginal canal 112 may have anatomically-accurate dimensions. For example, the vaginal canal 112 may be about 70 mm in length, with an inner canal diameter of about 22 mm. The vaginal canal 112 may have a wall thickness of about 5 mm. The inner canal diameter may change throughout the length of the canal. For example, the inner canal diameter may be narrower at the viewing end 114 and wider at the open end 116, to replicate human female anatomy. The outer canal diameter may also change throughout the length of the canal.

A user of the training apparatus 100 may look at the anatomy model 110 from the viewing end 114, to see through the vaginal canal 112 and out the open end 116, at any object that may be visible past the open end 116, such as a cervix model, as will be described below.

The vaginal canal 112 may extend linearly from the viewing end 114 to the open end 116, as shown in FIG. 2A, providing an unobstructed view out the open end 116 for a user, as shown in FIG. 2B. In an embodiment, the vaginal canal 112 may curve between the viewing end 114 and the open end 116, in a direction that replicates human female anatomy, such as downwards, then upwards. In this embodiment, the view out the open end 116 may be obstructed by the curved canal when viewed from the viewing end 114, and procedural tools, such as a speculum or spatula, may be required to prop open or lift the curved canal to better visualize the open end 116. A curved canal may represent normal female anatomy, or may represent abnormal conditions such as organ prolapse, in which an organ, such as the bladder or uterus sits on the vaginal canal 112, narrowing its inner canal diameter.

The anatomy model 110 may include a vulva 118. The vulva 118 may extend outwards from the viewing end 114 of the vaginal canal 112. When a user of the training apparatus 100 views the anatomy model 110 from the viewing end 114, they may view into the vaginal canal 112 through the surrounding vulva 118. The vulva may include a smooth outer portion defining a labia majora and a pliable vulvar opening formed by opposing flap-like structures defining labia minora.

The interior of the vaginal canal 112 may be a smooth wall, or alternatively, it may include ridges, striations, impressions, protrusions, and ring-like structures, to replicate human female anatomy.

The anatomy model 110 may include other anatomical features. For example, the anatomy model 110 may include a protruding ridge defining a clitoral hood, a clitoris, a hole defining a urethra, and a hole defining an anus.

The anatomy model 110 may be positioned such that the vaginal canal 112 is at an angle relative to a surface on which the training apparatus 100 sits. In particular, the vaginal canal 112 may be positioned at an angle of 30° to 60° relative to a horizontal axis, which may be represented by the surface on which the training apparatus 100 sits. Without being bound by any particular theory, the vaginal canal 112 of the present disclosure may be preferably oriented at around a 45° angle for conducting anatomical simulations, and in particular for hands-free anatomical simulations whereby a user does not need to hold the anatomy model 110.

The anatomy model 110 may be positioned by an optional stand 120, as shown in FIGS. 1A and 1B. In an embodiment, the anatomy model 110 may be self-supporting. In this embodiment, the anatomy model 110 may include structural elements of a same material or a different material. The structural elements may position the anatomy model 110 at the angle described above.

The anatomy model 110 of the present disclosure may be made of any suitable material. In one embodiment, the anatomy model 110 may be made or comprised of a natural rubber, synthetic rubber, urethane, polyurethane, silicone, the like, or combination thereof.

The entirety or a portion of the material (e.g. silicone) of the anatomy model 110 may have a hardness as measured according to the Shore 00 hardness scale of between 0 and 30. In an embodiment, the entirety or a portion of the material (e.g. silicone) of the anatomy model 110 may have a hardness as measured according to the Shore A hardness scale of between 0 and 30. In another embodiment, the entirety or a portion of the material (e.g. silicone) of the anatomy model 110 may have a Shore hardness as measured according to standard ASTM D2240 of between 00-30. Certain components or features of the anatomy model 110 may be of a different hardness. For example, in one embodiment the smooth outer portion defining a labia majora may have a greater hardness than the opposing flap-like structures defining labia minora. In another embodiment, the entirety of the anatomy model 110 may have the same hardness.

The vaginal canal 112 of the anatomy model 110 may be made of a material that has a pink colour. The vulva 118 of the anatomy model may be made of a material with a flesh tone colour. By “flesh tone colour”, it is meant a colour matching the colour of a person's skin, the person being of any race and/or ethnicity.

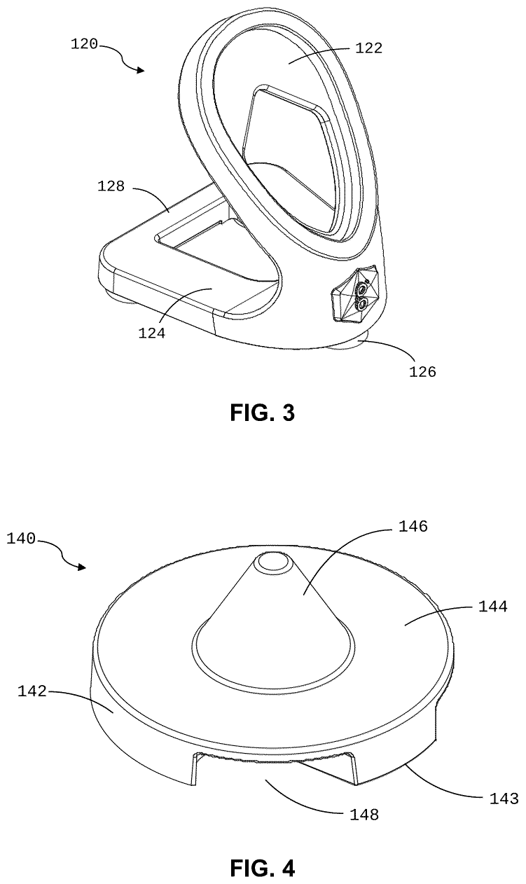

Referring now to FIG. 3, an exemplary stand 120 for use with the training apparatus 100 is shown. The stand 120 may be used to position the anatomy model 110 at the angle described above. The anatomy model 110 may be detachably engaged to the stand 120. The stand 120 may include ornamental designs, such as a logo.

The stand 120 may include a cradle 122, for positioning the anatomy model 110. The cradle 122 may comprise a recess in which the vulva 118 of the anatomy model 110 can rest, and a hole through which the vaginal canal 112 can extend. The recess may have smaller dimensions than the anatomy model 110, such that the anatomy model 110 can interference fit into the cradle 122.

The stand 120 may include one or more legs 124, descending underneath the cradle 122. The one or more legs 124 may have a particular height and length to properly position the anatomy model 110 with the rest of the cervix display 130. The one or more legs 124 may provide stability for the stand 120.

The one or more legs 124 may include one or more surface grips 126. The one or more surface grips 126 may secure the stand 120 to a surface on which the training apparatus 100 sits, to secure the training apparatus 100 in place while a user simulates a pelvic examination. In an exemplary embodiment, the one or more surface grips 126 are suction cups. In another exemplary embodiment, the one or more surface grips 126 are silicone pieces. The one or more surface grips 126 may be coupled to the one or more legs 124, such as by insertion of the one or more surface grips 126 into recesses in the one or more legs 124.

The stand 120 may include a positive alignment pattern 128. In the embodiment of FIG. 3, the positive alignment pattern 128 comprises a crossbar between the one or more legs 124. In other embodiments, other positive alignment patterns may be used. The positive alignment pattern 128 of the stand 120 may be insertable into a corresponding negative alignment pattern of the base 140 of the cervix display 130, to lock the two components together and to ensure their proper positioning, as will be described below.

The cervix display 130 will now be described in further detail. Referring first to FIG. 4, shown therein is an exemplary base 140 of the cervix display 130.

The base 140 may comprise a base body 142. The base body 142 may comprise a base surface 143, and a sliding surface 144 opposite the base surface. In one embodiment, the base surface 143 is flat and rests on the surface that the training apparatus 100 is placed on, such as a table or a desk. In another embodiment, one or more surface grips are coupled to the base surface 143. The one or more surface grips may secure the base 140 to the surface on which the training apparatus 100 sits, to hold the training apparatus 100 in place while a user simulates a pelvic examination. The one or more surface grips may be identical to the one or more surface grips 126 of the stand 120. In an exemplary embodiment, the one or more surface grips are suction cups. In another exemplary embodiment, the one or more surface grips are silicone pieces. The one or more surface grips may be coupled to the base surface 143 by insertion of the one or more surface grips into recesses in the base surface 143.

The sliding surface 144 may be flat and may support the movable holder 150. The movable holder 150 may sit and slide on the sliding surface 144 of the base 140.

The base body 142 may be any shape. In the embodiment of FIG. 4, the base body 142 is cylindrical. In the embodiment of FIG. 20, which will be described later, the base body 242 is rectangular. In embodiments, the base body may be polygonal, star-shaped, or flower-shaped.

The base body 142 may include a negative alignment pattern 148. The negative alignment pattern 148 may comprise a recess in the base surface 143 of the base body 142. The negative alignment pattern 148 may correspond with a positive alignment pattern 128 of the stand 120. In the embodiment shown, the negative alignment pattern 148 includes two parallel recesses and one perpendicular recess joining the ends of the two parallel recesses. This pattern corresponds to the two parallel legs and the perpendicular crossbar conjoining the legs of the stand 120. The positive alignment pattern 128 of the stand 120 may be inserted into the negative alignment pattern 148 of the base body 142, to lock the two components together and to ensure their proper positioning.

As mentioned above, the movable holder 150 may sit and slide on the sliding surface 144 of the base 140. The movable holder 150 and the base 140 may be made from materials with low friction coefficients, therefore sliding may be smooth between components.

One or more motion-limiting formations 146 of the base 140 may extend from the base body 142 and define a path of motion for the movable holder 150. A path of motion may be translational (e.g. a linear path of motion), rotational (e.g. a circular path of motion), or a combination of translational and rotational. The path of motion may have a starting point and an end point. The starting and end points may define minimum and maximum distances or angles the movable holder 150 can travel on the base 140. Alternatively, the path of motion may be continuous (e.g. for a circular path of motion), and there may not be limits to the distances or angles the movable holder 150 can travel on the base 140.

The one or more motion-limiting formations 146 may engage with a corresponding negative fitting of the movable holder 150. By fitting the one or more motion-limiting formations 146 into the negative fitting of the movable holder 150, the components are locked together, and motion is restricted to certain axes. In another embodiment, the one or more motion-limiting formations 146 may create boundaries, such as walls, on the sliding surface 144, which constrain the path of motion of the movable holder 150 to within the boundaries.

In the embodiment of FIG. 4, the one or more motion-limiting formations 146 is a cylindrical pin, centered on the base 140. When a corresponding negative fitting of movable holder 150 is placed on the base 140, the cylindrical pin prevents the movable holder 150 from translating in any horizontal direction (i.e. along an X or Y axis). (However, as the movable holder 150 sits on the base 140, it may still be translated vertically, along the Z-axis, for its removal from the base 140). The cylindrical pin defines a rotational path of motion, as the movable holder 150 may not translate, but may rotate around the cylindrical pin. The cylindrical pin defines an axis of rotation through its center. The movable holder 150 may rotate freely 360° around the cylindrical pin, in either a clockwise or counterclockwise direction.

As shown in FIG. 4, the cylindrical pin may be tapered. In other words, the cylindrical pin may have a first end that connects to the sliding surface 144 of the base 140, and a second end opposite the first end, and the first end may have a larger diameter than the second end. Without being bound by any particular theory, tapering the cylindrical pin may increase the strength at the transition between the base body 142 and the cylindrical pin, compared to a non-tapered transition, such as a 90° angle. Any shape of the one or more motion-limiting formations 146 may be tapered.

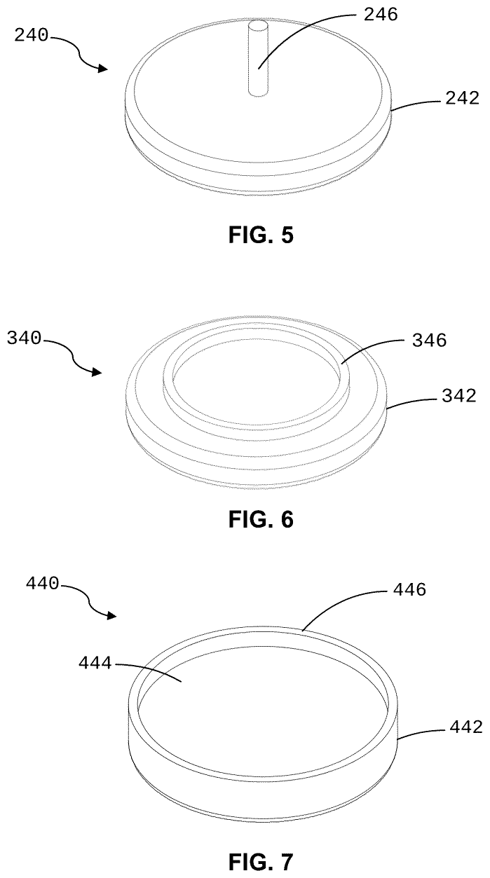

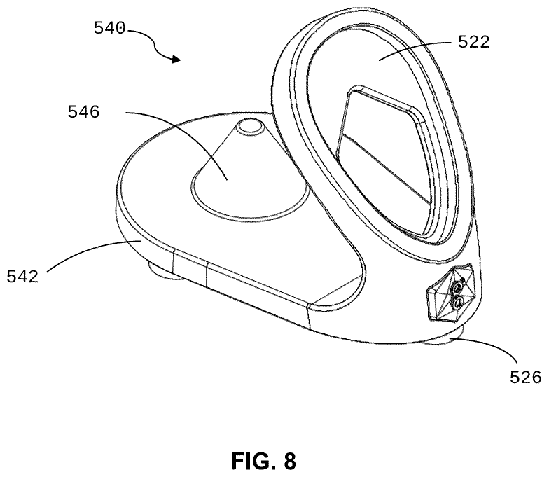

Referring now to FIGS. 5-7, shown therein are embodiments for the one or more motion-limiting formations 146 that may define a rotational path of motion. In the embodiment of FIG. 5, the one or more motion-limiting formations 246 of the base 240 is a non-tapered cylindrical pin. A non-tapered cylindrical pin may have reduced friction between itself and a corresponding negative fitting of the movable holder compared to a tapered cylindrical pin, due to a reduced surface area of contact. However, the non-tapered cylindrical pin may be more likely to break from the base body 242, due to the sharp 90° angle of its connection point. In the embodiment of FIG. 6, the one or more motion-limiting formations 346 of the base 340 is a circular track. The circular track may be less likely to break from the base body 342 than the non-tapered cylindrical pin of FIG. 5. However, without being bound by any particular theory, friction may be increased due to a larger surface contact area between the circular track and a corresponding negative fitting of the movable holder. In the embodiment of FIG. 7, the one or more motion-limiting formations 446 of the base 440 is a circular wall. The circular wall is configured to surround the movable holder when the movable holder is placed on the sliding surface 444 of the base body 442, restricting the horizontal translation motion of the movable holder, but permitting rotation. In this embodiment, the base 440 has a larger diameter than the movable holder.

Referring now to FIG. 8, shown therein is an embodiment wherein the base 540 comprises the stand. The base 540 may include elements of the stand 120 and the base 140, such as the cradle 522, the one or more surface grips 526, the base body 542, and the one or more motion-limiting formations 546. The positive alignment pattern 128 of the stand 120 and the negative alignment pattern 148 of the base 140 are not needed in this embodiment. The base 540 may be used in place of the base 140 and the stand 120 in training apparatus 100.

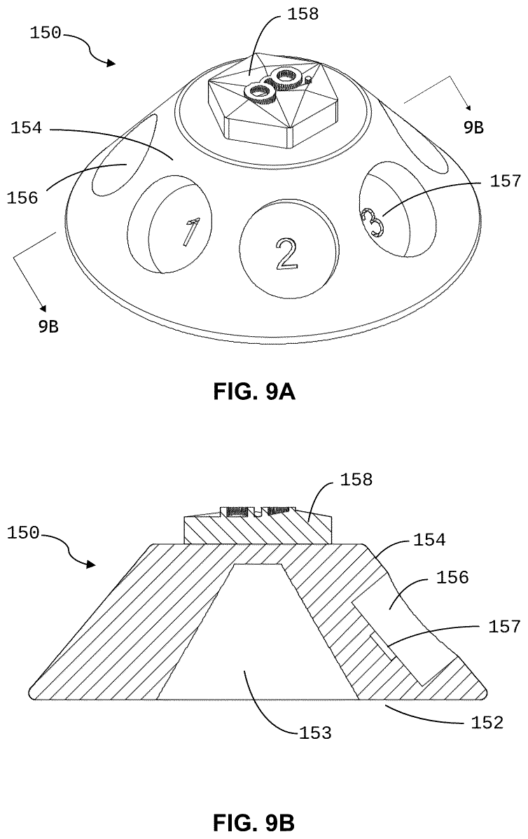

Referring now to FIGS. 9A and 9B, shown therein is an embodiment of the movable holder 150. FIG. 9A shows a perspective view of the movable holder 150, and FIG. 9B shows a section view of the movable holder 150 taken along line 9B-9B of FIG. 9A.

The movable holder 150 may include a bottom surface 152, which may be flat. The bottom surface 152 may sit on and slide on the sliding surface 144 of the base 140. The movable holder 150 may slide freely on the sliding surface 144 of the base 140, the sliding inhibited only by the friction that exists between the surfaces. The base 140 and the movable holder 150 may be made from materials with a low friction coefficient.

In one embodiment, the movable holder 150 may include a negative fitting 153. The negative fitting 153 may be a recess in the bottom surface 152, whose shape matches that of the one or more motion-limiting formations 146 of the base 140. The negative fitting 153 may fit over the one or more motion-limiting formations 146, such that the motion of the movable holder 150 is constrained.

In an embodiment, wherein the one or more motion-limiting formations 146 of the base 140 create boundaries on the sliding surface 144, beyond the movable holder 150 (such as the embodiment of FIG. 7), the movable holder 150 may not include a negative fitting 153.

The movable holder 150 may include a holder surface 154. The holder surface may include two or more cervix model receiving formations. In the embodiment shown, the two or more cervix model receiving formations are a plurality of cavities 156, recessed in the holder surface 154. The plurality of cavities 156 may include any number of cavities more than one. In the embodiments of FIGS. 1A, 1B, 9A, 9B, 10-14, 15A and 15B, the movable holder (150, 250, 350, 450, 550, 650 and 750) has seven or eight cavities (156, 256, 356, 456, 556, 656 and 756). The plurality of cavities 156 may be positioned equidistant from one another.

The plurality of cavities 156 may house the plurality of cervix models 160. The plurality of cavities 156 may position the plurality of cervix models 160 at an angle relative to a surface on which the training apparatus sits. The angle may be such that each cervix model, in turn, may align with the open end 116 of the vaginal canal 112 of the anatomy model 110 when the movable holder 150 is slid on the base 140 along the path of motion.

In an embodiment (not shown), the two or more cervix model receiving formations may be a plurality of projections, rather than a plurality of cavities 156, for positioning the plurality of cervix models 160. The plurality of cervix models 160 may be coupled to the plurality of projections (e.g. interference fit or fastened onto the projections).

In the embodiment of FIGS. 9A and 9B, the movable holder 150 is conical. The inclined holder surface 154 of the movable holder 150 allows for proper positioning of the plurality of cervix models 160 in the movable holder 150 to align with the open end 116 of the vaginal canal 112 of the anatomy model 110. The holder surface 154 extends at an angle from the bottom surface 152 that matches the angle of the vaginal canal 112 (i.e. between 30° and 60° degrees from the surface on which the training apparatus 100 is placed, such as at an angle of about 45°). The plurality of cavities 156 are recessed perpendicular to the holder surface 154, so their angle matches that of the open end 116 of the vaginal canal 112. When the plurality of cervix models 160 are inserted into the cavities 156, they too are positioned at an angle that matches that of the open end 116 of the vaginal canal 112. When the movable holder 150 slides along the path of motion, each cervix model, in turn, is moved into alignment with the open end 116.

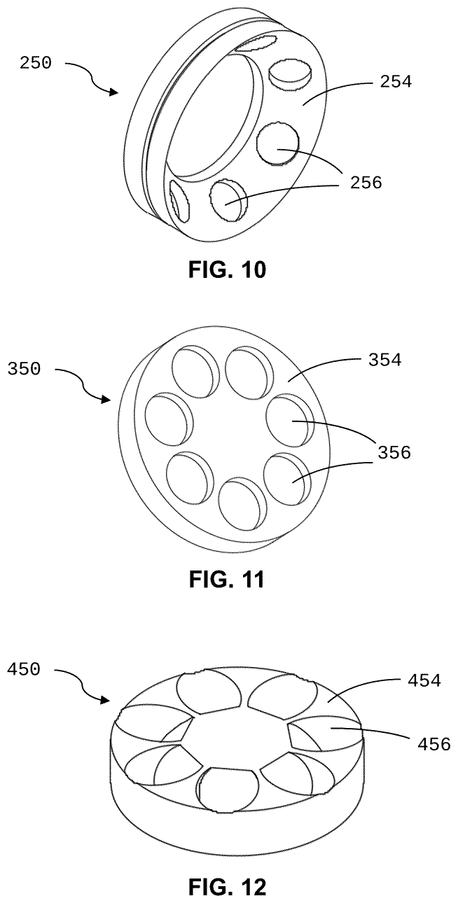

Referring now to FIGS. 10-12, shown therein are embodiments of the movable holder 150, which may position the plurality of cervix models 160 at the required angle. In the embodiment of FIG. 10, the movable holder 250 is a vertical plate with an inwardly inclined holder surface 254. The plurality of cavities 256 are recessed perpendicularly to the inclined holder surface 254. The cavity at the lowest position is at an angle that may match that of the open end 116 of the vaginal canal 112. The movable holder 250 may be rotated about its central axis, on a base, to position a new cavity (and the corresponding cervix model housed in the cavity) into the lowest position. In the embodiment of FIG. 11, the movable holder 350 is an angled plate, with the plurality of cavities 356 recessed perpendicular to the holder surface 354. In this embodiment, the entire movable holder 350 is mounted at an angle that may match that of the vaginal canal 112 of the anatomy model 110. In the embodiment of FIG. 12, the movable holder 450 is a horizontal plate. The plurality of cavities 456 are recessed into the movable holder 450 at an angle that may match the angle of the vaginal canal 112. Each movable holder 250, 350, and 450 shown in FIGS. 10-12 may require a uniquely designed base that will allow the movable holder to move as intended.

Returning now to FIGS. 9A and 9B, the plurality of cavities 156 may optionally include cavity numbering 157. Cavity numbering 157 may assist with identification of each cervix model housed in the plurality of cavities 156. For example, in one embodiment, the movable holder 150 may house a plurality of cervix models 160 with cervical pathologies, as will be described below. If accompanied by a paper legend, the cavity numbering 157 may help healthcare professionals to identify pathologies and test trainees.

As described herein, each movable holder 150 may comprise two or more cavities 156, each for receiving a cervical model 160. In an embodiment, each movable holder has between 2-20 cavities 156 for receiving a cervical model 160, more particularly between 2-10 cavities, and more particularly still between 2-8 cavities. In an embodiment, each moveable holder 150 has 1, 2, 3, 4, 5, 6, 7, 8, 9, 10, 11, 12, 13, 14, 15, 16, 17, 18, 19, 20, or more cavities. In an embodiment, each movable holder has between 4-8 cavities.

In an embodiment, each cavity 156 of a particular movable holder 150 has a cervical variation of an unrelated pathology, cause or physical feature. For example, in an embodiment, a single movable holder 150 may include cervical models 160 for different cancer pathologies, different sexually transmitted infections (STIs), different procedural variations, different parity variations, or any combination thereof.

In other embodiments, each cavity 156 of a particular movable holder 150 has a cervical variation of a related pathology, cause or physical feature. For example, in an embodiment, a single movable holder 150 may include various different cervical models 160 for cancer pathologies. In another embodiment, a single movable holder 150 may include various different cervical models 160 for sexually transmitted infections (STIs). In another embodiment, a single movable holder 150 may include various different cervical models 160 for procedural variations. In another embodiment, a single movable holder 150 may include various different cervical models 160 for parity variations.

The movable holder 150 may include one or more grips 158. The one or more grips 158 may provide a surface that can be grasped and pushed by a user, to assist the user with sliding the movable holder 150 on the base 140. The one or more grips 158 may be of a shape that is optimal for grasping. In the embodiment of FIGS. 9A and 9B, the one or more grips 158 is a hexagonal prism extending from the top of the movable holder 150. The one or more grips 158 may include ornamental designs, such as a logo.

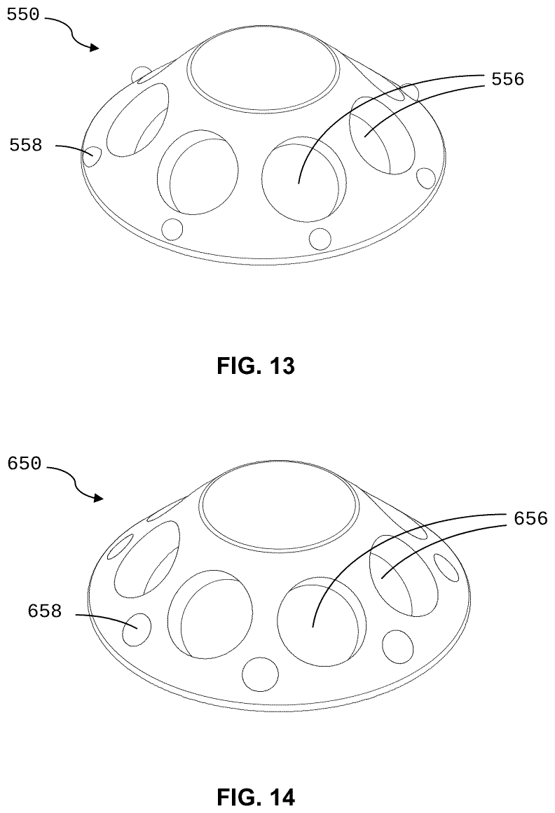

Referring now to FIGS. 13 and 14, shown therein are embodiments for the one or more grips 158. In the embodiment of FIG. 13, the one or more grips 558 on the movable holder 550 is a plurality of spheres, positioned underneath the plurality of cavities 556. The plurality of spheres may be of a size that they can easily be pushed by a finger of a user. The plurality of spheres may be labelled or numbered. Though shown as spheres, the plurality of spheres may take other shapes, such as hexagonal or rectangular prisms. In the embodiment of FIG. 14, the one or more grips 658 are a plurality of recessed holes. The plurality of recessed holes may be positioned between the plurality of cavities 656. Each recessed hole may be large enough for a finger to be inserted, such that a user can push on the recessed hole with their finger to slide the movable holder 650.

The movable holder 150 has herein been described to slide freely on the sliding surface 144 of the base 140, the sliding inhibited only by the friction that exists between the surfaces. In an embodiment, mechanisms may be used to prevent motion of the movable holder 150 on the base 140, when a cervix model aligns with the open end 116 of the vaginal canal 112. The movable holder 150 may slide freely when there are not any cervix models that align with the open end 116, but when any of the cervix models becomes aligned, motion may be prevented.

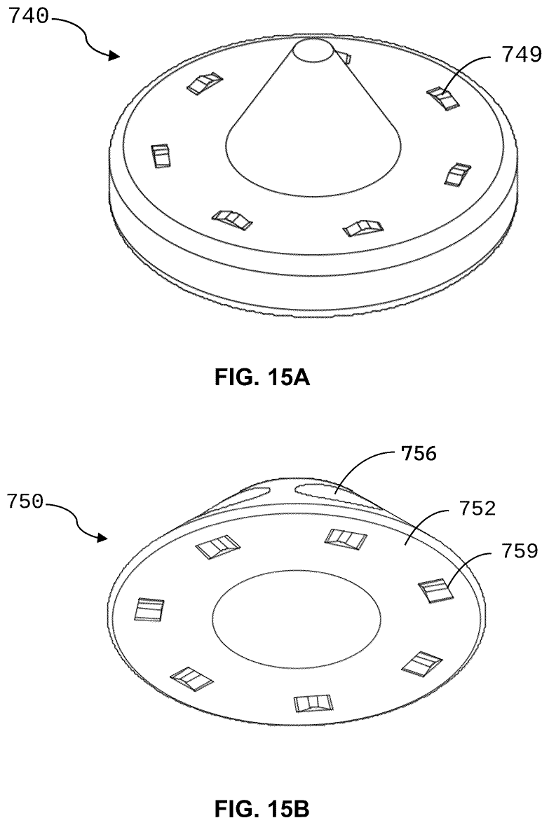

Referring now to FIGS. 15A and 15B, shown therein is an embodiment of a mechanism for preventing motion of the movable holder 750 when a cervix model is aligned with the open end 116 of the vaginal canal 112. FIG. 15A shows an embodiment of the base 740, which includes a plurality of positive notches 749. FIG. 15B shows a corresponding movable holder 750, which includes a plurality of negative notches 759. When a cervix model aligns with the open end 116 of the vaginal canal 112, the plurality of positive notches 749 may slide into the plurality of negative notches 759, locking the movable holder 750 in place with the base 740. The notches may be filleted, such that the movable holder 750 can slide up and out of the plurality of positive notches 749 with minimal difficulty, when a cervix model is moved out of alignment with the open end 116 (for example, in order to move a different cervix model into alignment). When the movable holder 750 is slid up and out of the plurality of positive notches, the bottom surface 752 of the movable holder 750 may slide on top of the plurality of positive notches 749, until the next cervix model aligns.

In another embodiment (not shown), magnets may be used to prevent motion of the movable holder 150 on the base 140 when a cervix model is aligned with the open end 116 of the vaginal canal 114. The base 140 may include a first magnet recessed in its sliding surface 144. The movable holder 150 may include a plurality of magnets recessed into its bottom surface 152. The plurality of magnets may comprise a number of magnets equivalent to a number of cervix models in the plurality of cervix models. Each magnet in the plurality of magnets may be positioned to correspond to a cervix model in the plurality of cervix models. When the movable holder 150 slides on the sliding surface 144 along the path of motion, the first magnet may attract a second magnet from the plurality of magnets. The strongest attraction between the first and second magnets may occur when the corresponding cervix model is aligned with the open end 116 of the vaginal canal 114. The attraction between the first and second magnets may hold the movable holder 150 in place on the base 140. A user may need to slide the movable holder 150 with a greater amount of strength to overcome the magnetic attraction between the first and second magnets to rotate the cervix model out of alignment. Another cervix model may then be aligned with the open end 116 when the first magnet attracts a different magnet in the plurality of magnets. Other arrangements of magnets than the one described in the embodiment above may also be used to prevent motion of the movable holder 150.

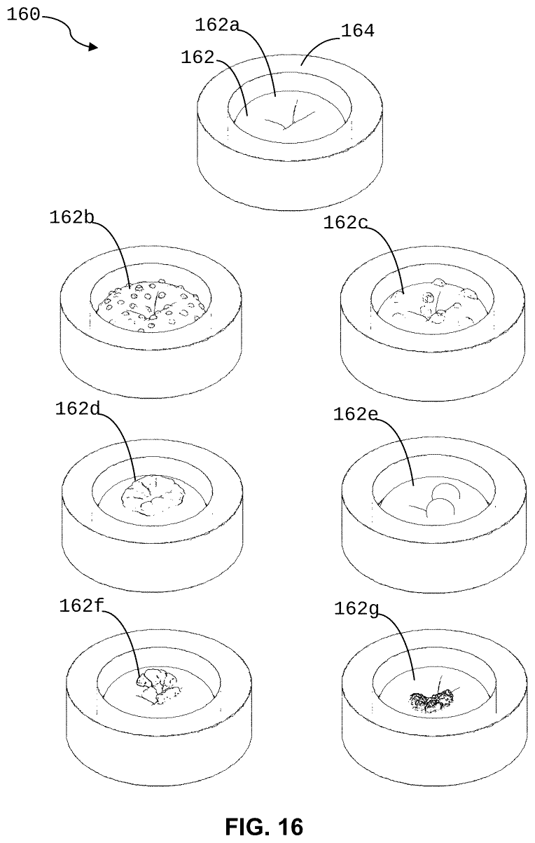

Referring now to FIG. 16, shown therein is an exemplary plurality of cervix models 160. The number of cervix models in the plurality of cervix models 160 may correspond to the number of cavities in the plurality of cavities 156. In the embodiment of FIGS. 1A and 16, the plurality of cervix models 160 includes seven cervix models.

Each cervix model in the plurality of cervix models 160 may comprise a cervix 162 with a cervical variation and a vaginal mount 164. The vaginal mount 164 may be identical among the plurality of cervix models 160, however each cervix 162 may have a unique cervical variation, therefore no two cervix models in the plurality of cervix models 160 may be the same.

The cervix 162 may resemble a real-life cervix as seen from its distal end (i.e. how a cervix would appear to a healthcare professional during a Pap smear). The cervix 162 may have anatomically-accurate dimensions, such as a diameter of about 20 mm.

Each cervix 162 may include a cervical variation that makes it unique. In the embodiment of FIG. 16, the cervical variations are cervical pathologies. In particular, cervix 162a is a normal healthy cervix, cervix 162b is a cervix with trichomoniasis, cervix 162c is a cervix with Nabothian cysts, cervix 162d is a cervix with ectropion, cervix 162e is a cervix with polyps, cervix 162f is a cervix with condyloma, and cervix 162g is a cervix with cancer. In other embodiments, other cervical pathologies may be shown. For example, other cervical pathologies that may be shown include cervical dysplasia, cervicitis, bacterial vaginosis, candidiasis, genital herpes, and syphilis (i.e. a syphilitic chancre).

In another embodiment, the cervical variations may be stages of pathological development. For example, the plurality of cervix models 160 may include cervix models displaying stages 1a, 1b, and 2 of cervical cancer, or cervix models displaying stages 1, 2, and 3 of cervical dysplasia/cervical intraepithelial neoplasia (CIN).

In another embodiment, the cervical variations may be degrees of cervical dilation. In this embodiment, the size of the external os of the cervix 162 may differ, and may range from 0 to 10 cm. The cervix models showing larger degrees of cervical dilation may also include anatomical elements of a fetus, such as a head and fontanelles.

In another embodiment, the cervical variations may be procedural variations. For example, the plurality of cervix models 160 may include a cervix 162 with a previous Loop Electrosurgical Excision Procedure (LEEP) or conization procedure, and a cervix 162 with an intrauterine device (IUD).

In another embodiment, the cervical variations may be parity variations. The plurality of cervix models 160 may include cervices with a nulliparous cervical variation, a uniparous cervical variation, a multiparous cervical variation, and a nulliparous pregnancy cervical variation.

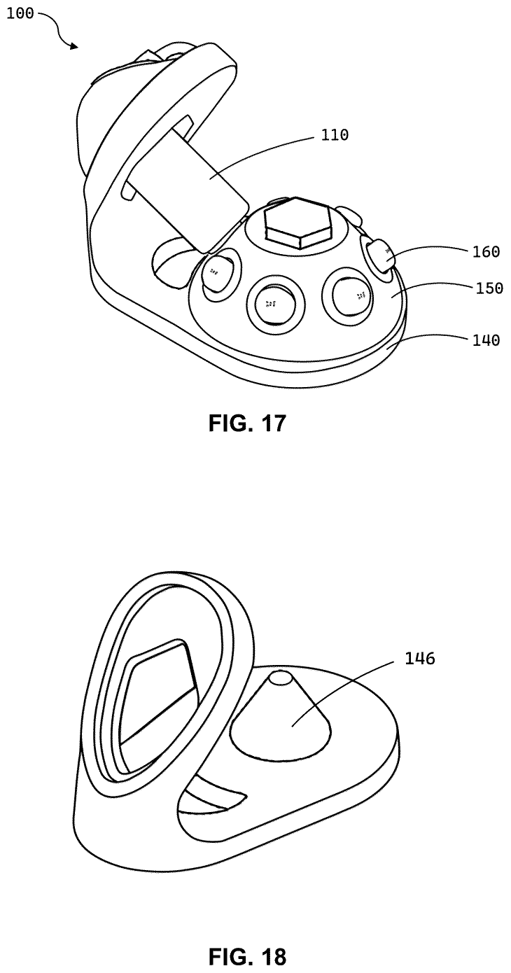

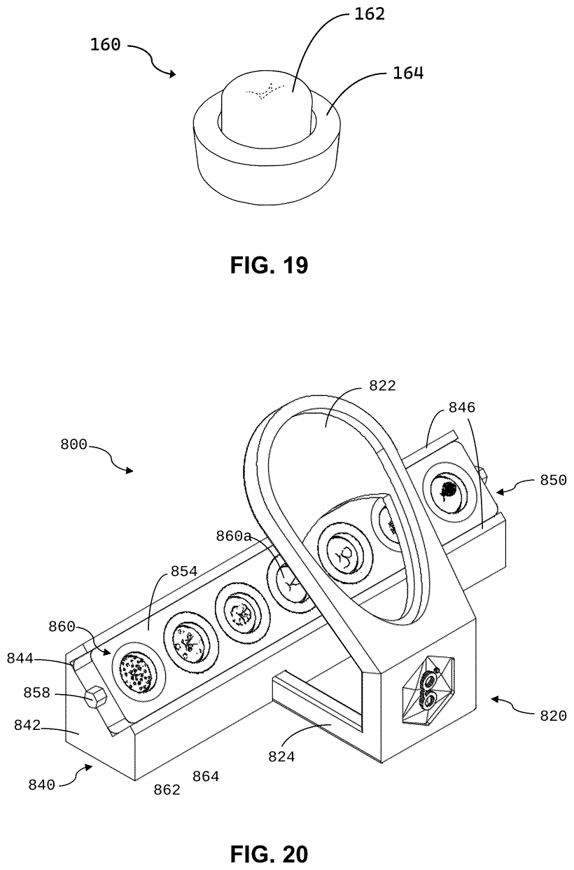

The vaginal mount 164 may support the cervix 162. The vaginal mount 164 may be a cylinder, on top of which the cervix 162 is positioned. Optionally, the vaginal mount 164 may include sidewalls that surround the cervix 162, as shown in FIG. 16. Optionally, the height of the cervix 162 may exceed the height of the sidewalls (such as shown in the embodiment of the training apparatus of FIG. 17 and the cervical model 160 of FIG. 19). The vaginal mount 164 replicates the portion of the vagina that would be seen around and behind the cervix during a visual examination of the cervix. The vaginal mount 164 may include an outer mount diameter. Wherein the vaginal mount 164 includes surrounding sidewalls, the vaginal mount 164 may also include an inner mount diameter. The inner mount diameter may match the inner canal diameter of the open end 116 of the vaginal canal 112. The outer mount diameter may match an outer canal diameter of the open end 116 of the vaginal canal 112. Therefore, when a selected cervix model 160a is aligned with the open end 116 of the vaginal canal 112, the inner and/or outer mount diameters may align with the open end 116 of the vaginal canal 112.

The plurality of cervix models 160 of the present disclosure may be made of any suitable material. In an embodiment, the plurality of cervix models 160 may be made or comprised of a natural rubber, synthetic rubber, urethane, polyurethane, silicone, the like, or combination thereof.

The entirety or a portion of the material (e.g. silicone) of the plurality of cervix models 160 may have a hardness as measured according to the Shore 00 hardness scale of between 0 and 30. In an embodiment, the entirety or a portion of the material (e.g. silicone) of the plurality of cervix models 160 may have a hardness as measured according to the Shore A hardness scale of between 0 and 30. In another embodiment, the entirety or a portion of the material (e.g. silicone) of the plurality of cervix models may have a Shore hardness as measured according to standard ASTM D2240 of between 00-30. Certain components or features of the plurality of cervix models 140 may be of a different hardness. For example, in an embodiment the vaginal mount 164 may have a greater hardness than the cervix 162. In another embodiment, the entirety of each cervix model in the plurality of cervix models 160 has the same hardness.

The plurality of cervix models 160 may be pink in colour. The colour may match that of the vaginal canal 112. In one embodiment, the cervix 162 and the vaginal mount 164 may be the same colour. In another embodiment, the cervix 162 and the vaginal mount 164 may be different colours.

The outer mount diameter of each cervix model may be slightly larger than the diameters of the plurality of cavities 156. The larger diameter may allow for an interference fits between the plurality of cervix models 160 and the plurality of cavities 156. For example, the outer mount diameter may be about 0.5 mm larger than the diameter of each cavity in the plurality of cavities 156.

As mentioned above, the plurality of cervix models 160 may be positioned at an angle relative to the surface on which the training apparatus 100 sits. In particular, the plurality of cervix models may be positioned at an angle of 30° to 60° relative to the surface on which the training apparatus 100 sits. It has been determined through extensive work and effort that the plurality of cervix models 160 of the present disclosure are best oriented at around a 45° angle for conducting anatomical simulations, and in particular for hands-free anatomical simulations whereby a user does not need to hold the anatomy model 110 or the plurality of cervix models 160. The plurality of cavities 156 may position the plurality of cervix models 160 at the required angle.

The plurality of cervix models 160 may also be removable from the plurality of cavities 156 and individually inserted into the open end 116 of the vaginal canal 112. Each cervix 162 may interference fit with the open end 116 of the vaginal canal 112. Wherein the vaginal mount 164 includes sidewalls surrounding the cervix, the sidewalls may assist with the interference fit by wrapping around the vaginal canal 112 at the open end 116, or the sidewalls may be folded back, and out of the way of cervix 162.

A selected cervix model 160a, as shown in FIGS. 1A and 1B, may be included and selected from the plurality of cervix models 160. Any cervix model from the plurality of cervix models 160 may be chosen as the selected cervix model 160a. To move a selected cervix model 160a into alignment with the anatomy model 110, the movable holder 150 may move on the base 140 according to the path of motion (e.g. rotational). Each cervix model in the plurality of cervix models 160 is configured to align with the anatomy model 110 at different points along the path of motion.

The plurality of cervix models 160, when inserted into the plurality cavities 156 may sit flush with the holder surface 154. When a cervix model is aligned with the open end 116 of the vaginal canal 112, there may be about 1 mm of spacing between the cervix model and the open end 116. Therefore, the movable holder 150 may slide along the path of motion without interference between the plurality of cervix models 160 and the anatomy model 110. However, when a cervix model is aligned with the open end 116, unwanted light entering from the gap between the anatomy model 110 and the cervix model is limited due to the 1 mm spacing.

Returning now to FIGS. 1A and 1B, it may be understood that the components of the training apparatus 100 (i.e. the anatomy model 110, the cervix model 130, and the stand 120) are intended to be used together. Furthermore, these elements may be disassembled and used separately. For example, the stand 120 may be disassembled from the base 140. A user may then use the anatomy model 110 or the anatomy model 110 and the stand 120, for displaying and demonstrating anatomical simulations with the anatomy model 110. For example, the anatomy model 110 may be used on its own for demonstrating various techniques, including but not limited to, massage techniques, Pap/pelvic examinations, contraception insertion and removal, female hygiene product insertion and removal, dilator usage, insertion and removal of devices for sexual health, pelvic wand usage anatomy lessons, and pre- and post-natal care techniques. Furthermore, the cervix display 130 may be used on its own. When used separately, a user can view all cervix models of the plurality of cervix models 160 simultaneously and can quickly compare each cervix model in the plurality of cervix models 160 to the other cervix models. The movable holder 150 may be moved on the base 140 to change the view of the plurality of cervix models 160 for the user.

The training apparatus herein has been described as displaying cervix models. In an embodiment, one or more uterus models may be included in the training apparatus. In one embodiment, a plurality of uterus models, the uterus models including cervices, are displayed rather than the plurality of cervix models 160. The plurality of uterus models may be housed in the movable holder 150. The plurality of uterus models may include cervical variations, such as those described above. In another embodiment, the plurality of uterus models may not include cervices. The plurality of cervix models 160 may be attachable to the plurality of uterus models. For example, the plurality of cervix models 160 may be attached to the plurality of uterus models using a fastening mechanism or an interference fit. In another embodiment, the anatomy model 110 may include a uterus model, as a separated component. The movable holder 150 may house the plurality of cervix models 160, as before, and the movable holder 150 may be positioned between the vaginal canal 112 and the uterus model. Therefore, a cervix model can be positioned in between the vaginal canal 112 and the uterus model, replicating female anatomy, by moving the cervix model into position using the movable holder 150. In any of the above-described embodiments, the uterus models may also include uterine variations. For example, the uterine variations may be uterine pathologies, and may include fibroids, cysts, tumours, cancer, adenomyosis, etc.

Optionally, the training apparatus 100 may include additional anatomical and/or ornamental elements. Additional anatomical and/or ornamental elements may further enhance the realism of simulations performed with the training apparatus 100 and the aesthetics of the training apparatus 100. In one embodiment, the training apparatus 100 may include a pelvis model that attaches to the stand 120. Without being bound by any particular theory, the pelvis model may improve the aesthetics of the training apparatus 100 and create spatial limitations for a healthcare professional performing a simulation with the training apparatus 100, thereby increasing its realism.

In the present disclosure, some pairs of elements are described as having positive projections and negative recesses, to assemble or interlock the elements with one another. A person of skill in the art may understand that the positive projections and negative recesses may be swapped on the elements, and the elements may still be assembled in the same way. For example, the base 140 has been described to comprise a negative alignment pattern 148, and the stand 120 has been described to comprise a positive alignment pattern 128. In an embodiment, the base 140 may comprise the positive alignment pattern 128, and the stand 120 may comprise the negative alignment pattern 148. Similarly, the base 140 has been described to comprise one or more motion-limiting formations 146, and the movable holder 150 has been described to optionally comprise a negative fitting 153. In an embodiment, the base 140 may comprise one or more motion-limiting recesses, and the movable holder 150 may comprise a positive fitting. Similarly, the base 740 has been described to comprise a plurality of positive notches 749, and the movable holder 750 has been described to comprise a plurality of negative notches 759. In an embodiment, the base 740 may comprise the plurality of negative notches 759, and the movable holder 750 may comprise the plurality of positive notches 749.

In the present disclosure, the anatomy model 110 is described as being stationary, while the plurality of cervix models 160 are described as being moveable to align with the vaginal canal 112. In an embodiment, the plurality of cervix models 160 may be stationary, and the anatomy model 110 may be moveable, to align the vaginal canal 112 with each cervix model in the plurality of cervix models 160.

Referring now to FIG. 17, shown therein is an alternate embodiment of a training apparatus 100 of the present disclosure. In the embodiment of FIG. 17, the stand 120 and the base 140 are a monolithic structure as shown in FIG. 18. However, as will be appreciated, alternate configurations of the stand 120 and base 140 may be used, such as those described herein for the training apparatus 100 of FIGS. 1A and 1B (e.g. FIGS. 3-8, 9A, 9B, 10-15, 15A and 15B). A unique feature of the training apparatus of FIG. 17 is that the cervix 162 of the plurality of cervical models 160 protrudes outwards from the vaginal mount 164. In some embodiments, this may be advantageous in presenting the pathology of the cervix to the open end 116 of the vaginal canal 112 of the anatomy model 110 (e.g. for viewing and/or physical interaction with an instrument). Also, in some embodiments, having the cervix 162 protrude outwards may be beneficial for indicating concentric alignment between the cervical model 160 and the open end 116 of the vaginal canal 112 of the anatomical model 110. For example, a user would be able to feel when the protrusion of the cervix 162 is within the open end of the vaginal canal 112, thereby avoiding the need for viewing alignment or having a physical feature that indicates alignment.

Referring to FIG. 19, shown therein is an exemplary embodiment of a cervical model 160 having a cervix 160 that protrudes outwards beyond the vaginal mount 164. The cervix 160 may extend outwards any suitable distance. In an embodiment, the cervix 162 is made of a sufficiently pliable material to conform or bend inwards towards the vaginal mount as it passes under the wall defining the open end 116 of the vaginal canal 112. The cervix 116 will then reform to its original shape once it is position in concentric alignment with the open end 116 of the vaginal canal 112. As described elsewhere herein, the cervical model 160 can present any of a number of procedural or parity variations and/or cervical pathologies. Any cervical variation (normal, abnormal or pathological) that can be presented on cervical model 160 is contemplated herein.

Referring now to FIG. 20, shown therein is another embodiment of a training apparatus 800 for simulating a pelvic examination. The training apparatus 800 may include similar components to the training apparatus 100, however in the embodiment shown, movable holder 850 slides on a base 840 along a translational path of motion, rather than a rotational path of motion.

Training apparatus 800 may include an anatomy model. However, for clarity, the anatomy model is not shown in FIG. 20. The anatomy model of training apparatus 800 may be the same as the anatomy model 110 of training apparatus 100. The anatomy model of training apparatus 800 may sit in the stand 820.

The training apparatus 800 may comprise stand 820. Stand 820 may comprise the cradle 822 for holding the anatomy model, and one or more legs 824. The stand 820 may have a positive alignment pattern (not shown) which interlocks with a negative alignment pattern (not shown) of the base 840. The stand 820 may include one or more surface grips (not shown) for securing the training apparatus 800 to a surface on which it sits.

The base 840 of training apparatus 800 may have a rectangular shape, with a sliding surface 844 inclined at an angle. The base 840 may include one or more motion-limiting formations 846. In the embodiment of FIG. 20, the one or more motion-limiting formations 846 are walls. The walls define a translational path of motion, restricting movement of the movable holder 850 on the base 840 to translation in a single axis (i.e. in the left-right direction, as upward-downward motion is restricted by the walls).

The movable holder 850 may sit on the sliding surface 844 of the base 840. The movable holder 850 may have the shape of a rectangular prism. The movable holder 850 may include a plurality of cavities, recessed into the holder surface 854. The sliding surface 844 of the base 840 may be angled, such that the plurality of cavities in the movable holder 850 can position a plurality of cervix models 860 housed in the plurality of cavities at an angle that matches an angle of the open end of the vaginal canal of the anatomy model. In particular, the vaginal canal may be positioned at an angle of 30° to 60° relative to the surface on which the training apparatus 800 sits. Without being bound by any particular theory, the vaginal canal of the present disclosure is preferably oriented at around a 45° angle for conducting anatomical simulations.

The movable holder 850 can include one or more grips 858. The one or more grips 858 may be grasped and pushed, to assist the user with sliding the movable holder 850 on the base 840, to align different cervix models with the open end of the vaginal canal of the anatomy model. In the embodiment of FIG. 20, the one more grips 850 are raised hexagonal prisms on each end of the movable holder 850.

The training apparatus 800 may include a plurality of cervix models 860. The cervix models may include vaginal mounts 864 and cervices 862 with cervical variations. In the embodiment shown, the cervical variations are cervical pathologies. A selected cervix model 860a may be selected from the plurality of cervix models 860. In the embodiment of FIG. 20, the selected cervix model 860a is already positioned in alignment with the anatomy model (not shown). Any cervix model from the plurality of cervix models 860 may be selected as the selected cervix model. To move a selected cervix model into alignment with the anatomy model, the movable holder 850 may be moved on the base 840 along the path of motion.

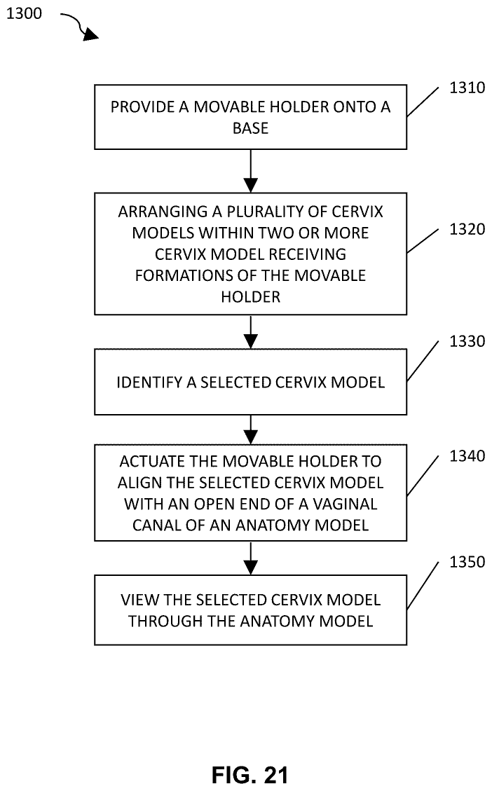

Referring now to FIG. 21, shown therein is an example method 1300 of simulating a pelvic examination, which will now be described. The method may be used with the training apparatuses 100 and 800.

At 1310, a movable holder may be provided onto a base. The movable holder and the base may be provided as part of a training apparatus. Providing a movable holder onto a base may include positioning a cavity of the movable holder onto a cylindrical pin of the base.

At 1320, a plurality of cervix models may be arranged within two or more cervix model receiving formations of a movable holder. The plurality of cervix models and the movable holder may be provided as part of a training apparatus. Arranging a plurality of cervix models in a movable holder may include fitting the plurality of cervix models into a plurality of cavities of the movable holder. The plurality of cervix models may be fit into the plurality of cavities using an interference fit. The arrangement or order of the plurality of cervix models may be any arrangement or order suitable including, but not limited to, categories of cervical pathologies, disease severity of cervical pathologies, similarly presenting cervical pathologies, or the like.

At 1330, a selected cervix model may be identified or selected from the plurality of cervix models. Identifying the selected cervix model comprises selecting one cervix model out of the plurality of cervix models to be viewed through an anatomy model.

Once the selected cervix model is identified, at 1340 the movable holder may be actuated to align the selected cervix model with the anatomy model. In particular, the selected cervix model may be concentrically aligned with an open end of a vaginal canal of the anatomy model.

Actuating the movable holder may include sliding the movable holder on a sliding surface of a base. As the plurality of cervix models are releasably received in the movable holder, the selected cervix model may be moved into concentric alignment by sliding the movable holder. The movable holder may be restricted to a certain path of motion defined by the base. Each cervix model in the plurality of cervix models may be configured to align with the anatomy model at different points along the path of motion.

Actuating the movable holder may include pushing the movable holder in a transverse direction along the sliding surface of the base, rotating the movable holder about an axis of rotation on the sliding surface of the base, or a combination of the two.

In one embodiment, alignment, including concentric alignment, may be determined visually. Wherein the vaginal mount and the vaginal canal at the open end have a same inner diameter, concentric alignment occurs when the inner mount diameter and the inner canal at the open end align. Wherein the vaginal mount and the vaginal canal at the open end have a same outer diameter, concentric alignment occurs when the outer mount diameter and the outer canal at the open end align. Wherein the inner and outer mount diameters differ from the inner and outer canal diameters, concentric alignment occurs when a center point of the cervix model aligns with a center point of the vaginal canal at the open end.

In an embodiment, the training apparatus may indicate when concentric alignment has occurred. For example, FIGS. 15A and 15B show an embodiment wherein movement of the movable holder 750 is hindered when concentric alignment occurs, as the plurality of positive notches 749 of the base 740 slot into the plurality of negative notches 759 of the movable holder 750.

Returning now to FIG. 21, once concentric alignment has occurred, at 1350 the selected cervix model may be viewed through the anatomy model. Viewing the selected cervix model through the anatomy model may include viewing the selected cervix model from a viewing end of the anatomy model, through the vaginal canal, and out the open end. Viewing the selected cervix model through the anatomy model may also include viewing the selected cervix model through a surrounding vulva of the anatomy model.

At 1350, viewing or conducting a pelvic examination of the selected cervix model through the anatomy model may further comprise: applying a lubricating substance to the anatomy model and inserting a speculum into the vaginal canal of the anatomy model.

At 1350, viewing or conducting a pelvic examination of the selected cervix model through the anatomy model may further comprise applying an acetic acid solution to the selected cervix model. A skilled person will understand that any material or substance may be applied to any part of the anatomy model or the selected cervix model, as may be used or applied during a pelvic examination, routine or otherwise.

Optionally, at 1350 a user may perform a procedure on the selected cervix model through the anatomy model. In one embodiment, the procedure is a Pap smear. In this embodiment, performing a procedure on the selected cervix model through the anatomy model may comprise: applying a lubricating substance to the anatomy model, inserting a speculum into the vaginal canal of the anatomy model, inserting a swab and/or spatula into the vaginal canal through the viewing end, and swabbing the selected cervix model using the swab and/or spatula.

In an embodiment, the procedure is a colposcopy. In this embodiment, performing a procedure on the selected cervix model through the anatomy model may comprise: applying a lubricating substance to the anatomy model, inserting a speculum into the vaginal canal of the anatomy model, aligning a colposcope with the viewing end of the anatomy model, and viewing the selected cervix model through the colposcope.

In an embodiment, the procedure is a cervical biopsy. In this embodiment, performing a procedure on the selected cervix model through the anatomy model may comprise: applying a lubricating substance to the anatomy model, inserting a speculum into the vaginal canal of the anatomy model, inserting forceps into the vaginal canal, clasping the selected cervix model with the forceps, inserting a cutting tool into the vaginal canal, and removing a portion of the selected cervix model with the cutting tool.

In an embodiment, the procedure is endocervical curettage. In this embodiment, performing a procedure on the selected cervix model through the anatomy model may comprise: applying a lubricating substance to the anatomy model, inserting a speculum into the vaginal canal of the anatomy model, inserting a curette into the vaginal canal, and inserting the curette into the selected cervix model.

In an embodiment, the procedure is a late pregnancy cervical examination. In this embodiment, performing a procedure on the selected cervix model through the anatomy model may comprise: applying a lubricating substance to the anatomy model, inserting one or more fingers into the anatomy model, probing the selected cervix model, and measuring the degree of cervical dilation of the selected cervix model.

### EXEMPLARY EMBODIMENTS

The following are non-limiting exemplary embodiments of the training apparatuses, kits, uses and methods of the present disclosure.

(1) A training apparatus for simulating a pelvic examination, comprising: an anatomy model comprising a vaginal canal, the vaginal canal having a tube-like structure and comprising a viewing end and an open end opposite the viewing end; a plurality of cervix models, each cervix model of the plurality of cervix models for displaying a cervical pathology; a movable holder comprising two or more cervix model receiving formations, each of the cervix model receiving formations for removably attaching one of the cervix models; and a base for supporting the movable holder, the base comprising one or more motion-limiting formations for defining a path of motion of the movable holder upon the base, and the base configured to align each cervix model of the plurality of cervix models with the open end of the vaginal canal upon movement of the movable holder along the path of motion.

(2) The training apparatus of (1), wherein the anatomy model further comprises a vulva extending outward from the vaginal canal at the viewing end.

(3) The training apparatus of (1) or (2), further comprising a stand for supporting the anatomy model that is configured to align, in cooperation with the base, the open end of the vaginal canal with each cervix model of the plurality of cervix models upon movement of the movable holder.

(4) The training apparatus of (3), wherein the stand and the base are a monolithic unit.

(5) The training apparatus of (3), wherein the stand and the base are capable of being releasably interconnected.

(6) The training apparatus of (5), wherein the releasable interconnection comprises a positive alignment pattern on one of the base or the stand and a negative alignment pattern on the other one of the base or the stand.

(7) The training apparatus of any one of (3) to (6), wherein the stand further comprises one or more surface grips on a bottom surface of the stand.

(8) The training apparatus of any one of (3) to (7), wherein the stand positions a longitudinal length of the vaginal canal of the anatomy model at a first angle within a range of about 30° and 60° relative to a horizontal axis.

(9) The training apparatus of any one of (1) to (8), wherein the base positions the movable holder in an orientation such that a feature surface of each cervix model of the plurality of cervix models is at an angle of about 90° relative to the longitudinal length of the vaginal canal.

(10) The training apparatus of (8) or (9), wherein the movable holder positions the plurality of cervix models at a second angle within a range of about 30° and 60° relative to a horizontal axis.

(11) The training apparatus of any one of (1) to (10), wherein each of the two or more cervix model receiving formations comprises one or both of a cavity and a protrusion.

(12) The training apparatus of any one of (1) to (11), wherein each of the two or more cervix model receiving formations comprises a cavity.

(13) The training apparatus of any one of (1) to (11), wherein each of the two or more cervix model receiving formations comprises a protrusion.

(14) The training apparatus of any one of (1) to (13), wherein each of the two or more cervix model receiving formations are positioned equidistant from one another.

(15) The training apparatus of any one of (1) to (14), wherein the path of motion is rotational.

(16) The training apparatus of (15), wherein the one or more motion-limiting formations comprises a cylindrical pin.

(17) The training apparatus of (16), wherein the cylindrical pin comprises a first end connecting to the base and a second end opposite the first end, wherein a first diameter of the first end is larger than a second diameter of the second end.

(18) The training apparatus of any one of (15) to (17), wherein the movable holder has a conical shape.

(19) The training apparatus of any one of (1) to (14), wherein the path of motion is translational.

(20) The training apparatus of (19), wherein the one or more motion-limiting formations is a wall or a ridge.

(21) The training apparatus of any one of (1) to (20), wherein the base and the movable holder comprise a plurality of alignment formations that, when in operation, aligns each cervix model of the plurality of cervix models with the open end of the vaginal canal upon movement of the movable holder along the path of motion.

(22) The training apparatus of (21), wherein the plurality of alignment formations comprises a plurality of protrusions on the base and a plurality of recesses on the moving holder.

(23) The training apparatus of (21), wherein the plurality of alignment formations comprises at least one base magnet on the base and a plurality of holder magnets on the moving holder.

(24) The training apparatus of any one of (1) to (23), wherein the movable holder further comprises one or more actuators.

(25) The training apparatus of (24), wherein the one or more actuators comprises one or more grips.

(26) The training apparatus of any one of (1) to (25), wherein each cervix model in the plurality of cervix models comprises a vaginal mount and a cervix.

(27) The training apparatus of (26), wherein the vaginal mount comprises a container defining a mount cavity, and the cervix is received within the mount cavity.

(28) The training apparatus of (26) or (27), wherein the open end of the vaginal canal comprises an inner canal diameter and an outer canal diameter.

(29) The training apparatus of (28), wherein the vaginal mount comprises an inner mount diameter and an outer mount diameter.

(30) The training apparatus of (29), wherein the inner mount diameter and the inner canal diameter are equal and/or the outer mount diameter and the outer canal diameter are equal.

(31) The training apparatus of (30), wherein each cervix model in the plurality of cervix models is configured to be releasably received into the open end of the vaginal canal through an interference fit.

(32) The training apparatus of any one of (1) to (31), wherein the cervical pathology comprises a normal cervix, a trichomoniasis cervix, a Nabothian cyst cervix, an ectropion cervix, a polyp cervix, a condyloma cervix, a cancer cervix, a dysplasia cervix, a cervicitis cervix, a bacterial vaginosis cervix, a candidiasis cervix, a genital herpes cervix, or a syphilis cervix.

(33) The training apparatus of any one of (1) to (32), wherein the anatomy model and the plurality of cervix models comprise silicone.

(34) The training apparatus of any one of (1) to (33), wherein the plurality of cervix models comprises at least three cervix models, and the two or more cervix model receiving formations comprise at least three cervix model receiving formations.

(35) The training apparatus of any one of (1) to (34), wherein the plurality of cervix models comprises at least seven cervix models, and the two or more cervix model receiving formations comprise at least seven cervix model receiving formations.

(36) The training apparatus of any one of (1) to (35), wherein the plurality of cervix models is configured to be releasably received in the two or more cervix model receiving formations through interference fits.

(37) The training apparatus of any one of (1) to (36), wherein the open end of the vaginal canal and the selected cervix model are separated by a space within a range of about 0.5 mm and about 3 mm when aligned.

(38) The training apparatus of any one of (1) to (37), wherein the open end of the vaginal canal and the selected cervix model are separated by a space of about 1 mm of space when aligned.

(39) The training apparatus of any one of (1) to (38), wherein the vaginal canal has a length within a range of about 50 mm and about 90 mm.

(40) The training apparatus of any one of (1) to (39), wherein the vaginal canal has a length of about 70 mm.

(41) A kit for simulating a pelvic examination, comprising: the training apparatus of any one of (1) to (40); and one or more procedural tools.

(42) The kit of (41), wherein the one or more procedural tools comprises a speculum, a swab, a spatula, a lubricating substance, a light, a colposcope, a curette, an acetic acid solution, forceps, or any combination thereof.

(43) The kit of (41) or (42), further comprising instructions for use of the training apparatus in a pelvic examination simulation.

(44) A use of the training apparatus of any one of (1) to (40) or the kit of any one of (41) to (43 for) simulating a pelvic examination.

(45) A use of the training apparatus of any one of (1) to (40) or the kit of any one of (41) to (43) for educating a user.

(46) The use of (45), wherein the user comprises a physician, a patient, a nurse, a student, an instructor, or any combination thereof.

(47) A method for simulating a pelvic examination, comprising steps of: providing a movable holder onto a base; arranging a plurality of cervix models within two or more cervix model receiving formations of the movable holder, each cervix model of the plurality of cervix models for displaying a cervical pathology; identifying a selected cervix model of the plurality of cervix models; actuating the movable holder along a path of motion defined by the base to align the selected cervix model of the plurality of cervix models with an open end of a vaginal canal of an anatomy model, the vaginal canal having a tube-like structure; and viewing or conducting a pelvic examination of the selected cervix model of the plurality of cervix models through the anatomy model from a viewing end of the vaginal canal.

(48) The method of (47), wherein the steps of arranging the plurality of cervix models, identifying the selected cervix model, actuating the movable holder, and viewing or conducting a pelvic examination of the selected cervix model are repeated.

(49) The method of (47) or (48), wherein the step of viewing or conducting a pelvic examination of the selected cervix model further comprises viewing or conducting the pelvic examination through a vulva.

(50) The method of any one of (47) to (49), further comprising a step of positioning the anatomy model on a stand to align, in cooperation with the base, the open end of the vaginal canal with the selected cervix model.

(51) The method of (50), further comprising a step of securing the stand to a surface.

(52) The method of (50) or (51), wherein the step of positioning the anatomy model on the stand comprises positioning a longitudinal length of the vaginal canal at a first angle within a range of about 30° and 60° relative to a horizontal axis.

(53) The method of (52), further comprising a step of orienting the base to position the movable holder such that a feature surface of the selected cervix model of the plurality of cervix models is at an angle of about 90° relative to the longitudinal length of the vaginal canal.

(54) The method of (52), further comprising a step of orienting the movable holder to position the plurality of cervix models at a second angle within a range of about 30° and 60° relative to a horizontal axis.

(55) The method of any one of (50) to (54), further comprising a step of connecting the base and the stand.

(56) The method of any one of (47) to (55), wherein the step of actuating the movable holder comprises rotating the movable holder on the base along the path of motion.

(57) The method of any one of (47) to (55), wherein the step of actuating the movable holder comprises translating the movable holder on the base along the path of motion.

(58) The method of any one of (47) to (57), wherein aligning the selected cervix model with the open end of the vaginal canal in the step of actuating the movable holder comprises registering one of a plurality of alignment formations of the movable holder with a respective one of a plurality of alignment formations of the base.

(59) The method of (58), wherein the plurality of alignment formations of the base comprise a plurality of protrusions and the plurality of alignment formations of the movable holder comprise a plurality of recesses.

(60) The method of (58), wherein the plurality of alignment formations of the base comprise at least one base magnet and the plurality of alignment formations of the movable holder comprise a plurality of holder magnets.

(61) The method of any one of (47) to (60), wherein aligning the selected cervix model with the open end in the step of actuating the movable holder comprises: aligning an inner mount diameter of the selected cervix model with an inner canal of the open end of the vaginal canal, wherein the inner mount diameter and an inner canal diameter of the inner canal are equal; and/or aligning an outer mount diameter of the selected cervix model with an outer canal of the open end of the vaginal canal, wherein the outer mount diameter and an outer canal diameter of the outer canal are equal.

(62) The method of any one of (47) to (61), wherein the step of actuating the movable holder comprises grasping and pushing one or more grips of the movable holder.

(63) The method of any one of (47) to (62), further comprising a step of identifying the cervical pathology of the selected cervix model.

(64) The method of any one of (47) to (63), wherein the cervical pathology comprises a normal cervix, a trichomoniasis cervix, a Nabothian cyst cervix, an ectropion cervix, a polyp cervix, a condyloma cervix, a cancer cervix, a dysplasia cervix, a cervicitis cervix, a bacterial vaginosis cervix, a candidiasis cervix, a genital herpes cervix, or a syphilis cervix.

(65) The method of any one of (47) to (64), wherein the step of arranging the plurality of cervix models within the two or more cervix model receiving formations comprises releasably receiving the plurality of cervix models within the two or more cervix model receiving formations through interference fits.

(66) The method of any one of (47) to (65), further comprising steps of: removing the selected cervix model from the movable holder; and placing the selected cervix model into the open end of the vaginal canal using an interference fit.

(67) The method of any one of (47) to (66), further comprising steps of: positioning a speculum within the vaginal canal through the viewing end of the vaginal canal; inserting a swab into the viewing end of the vaginal canal; and swabbing the selected cervix model with the swab through the vaginal canal.

(68) The method of (67) dependent from (49), further comprising a step of inserting the speculum through the vulva.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

It should be understood that while the models, stands, kits and uses are described herein in terms of “comprising,” “containing,” or “including” various components, features or steps, the compositions and methods can also “consist essentially of” or “consist of” the various components, features and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A training apparatus for simulating a pelvic examination, comprising:
an anatomy model comprising a vaginal canal, the vaginal canal having a tube-like structure and comprising a viewing end and an open end opposite the viewing end;
a plurality of cervix models, each cervix model of the plurality of cervix models for displaying a cervical pathology;
a movable holder comprising two or more cervix model receiving formations, each of the cervix model receiving formations for removably attaching one of the cervix models; and
a base for supporting the movable holder, the base comprising one or more motion-limiting formations for defining a path of motion of the movable holder upon the base, and the base configured to align each cervix model of the plurality of cervix models with the open end of the vaginal canal upon movement of the movable holder along the path of motion.

2. The training apparatus of claim 1, further comprising a stand for supporting the anatomy model that is configured to align, in cooperation with the base, the open end of the vaginal canal with each cervix model of the plurality of cervix models upon movement of the movable holder.

3. The training apparatus of claim 2, wherein the stand and the base are a monolithic unit.

4. The training apparatus of claim 2, wherein the stand and the base are capable of being releasably interconnected.

5. The training apparatus of claim 4, wherein the releasable interconnection comprises a positive alignment pattern on one of the base or the stand and a negative alignment pattern on the other one of the base or the stand.

6. The training apparatus of claim 2, wherein the stand positions a longitudinal length of the vaginal canal of the anatomy model at a first angle within a range of about 30° and 60° relative to a horizontal axis.

7. The training apparatus of claim 1, wherein:
the base positions the movable holder in an orientation such that a feature surface of each cervix model of the plurality of cervix models is at an angle of about 90° relative to the longitudinal length of the vaginal canal; and/or
the movable holder positions the plurality of cervix models at a second angle within a range of about 30° and 60° relative to a horizontal axis.

8. The training apparatus of claim 1, wherein each of the two or more cervix model receiving formations comprises a cavity.

9. The training apparatus of claim 1, wherein the path of motion is rotational.

10. The training apparatus of claim 9, wherein the one or more motion-limiting formations comprises a cylindrical pin and the movable holder has a conical shape.

11. The training apparatus of claim 1, wherein the path of motion is translational and the one or more motion-limiting formations is a wall or a ridge.

12. The training apparatus of claim 1, wherein the base and the movable holder comprise a plurality of alignment formations that, when in operation, aligns each cervix model of the plurality of cervix models with the open end of the vaginal canal upon movement of the movable holder along the path of motion.

13. The training apparatus of claim 12, wherein the plurality of alignment formations comprises a plurality of protrusions on the base and a plurality of recesses on the moving holder.

14. The training apparatus of claim 1, wherein each cervix model in the plurality of cervix models comprises a vaginal mount and a cervix.

15. The training apparatus of claim 14, wherein the vaginal mount comprises a container defining a mount cavity, and the cervix is received within the mount cavity.

16. The training apparatus of claim 14, wherein:
the open end of the vaginal canal comprises an inner canal diameter and an outer canal diameter;
the vaginal mount comprises an inner mount diameter and an outer mount diameter; and
the inner mount diameter and the inner canal diameter are equal and/or the outer mount diameter and the outer canal diameter are equal.

17. The training apparatus of claim 16, wherein each cervix model in the plurality of cervix models is configured to be releasably received into the open end of the vaginal canal through an interference fit.

18. The training apparatus of claim 1, wherein the cervical pathology comprises a normal cervix, a trichomoniasis cervix, a Nabothian cyst cervix, an ectropion cervix, a polyp cervix, a condyloma cervix, a cancer cervix, a dysplasia cervix, a cervicitis cervix, a bacterial vaginosis cervix, a candidiasis cervix, a genital herpes cervix, or a syphilis cervix.

19. The training apparatus of claim 1, wherein the plurality of cervix models comprises at least seven different cervix models, and the two or more cervix model receiving formations comprise at least seven cervix model receiving formations.

20. The training apparatus of claim 1, wherein the open end of the vaginal canal and the selected cervix model are separated by a space within a range of about 0.5 mm and about 3 mm when aligned.
